(19) United States
(12) Patent Application Publication
(10) Pub. No.: US 2015/0128579 A1
(43) Pub. Date: May 14, 2015

(54) METHOD AND SYSTEM FOR STORING ENERGY

(71) Applicant: SHELL OIL COMPANY, Houston, TX (US)

(72) Inventor: Andrew Stephen LAW, Spokane, WA (US)

(21) Appl. No.: 14/536,722

(22) Filed: Nov. 10, 2014

Related U.S. Application Data
(60) Provisional application No. 61/903,168, filed on Nov. 12, 2013.

(51) Int. Cl. F03B 13/00; F03B 13/06; F03B 1/00

(52) U.S. Cl. CPC F03B 13/00; F03B 1/00; F03B 13/06
USPC 60/327; 60/330

(57) ABSTRACT

A method is provided for storing energy including the steps of: during a time period when electrical energy is available at low prices, pumping water from a lower reservoir to a reservoir at a higher elevation wherein the difference between the elevation of the higher reservoir and the lower reservoir is at least 100 meters; during a time period when electrical energy is available at a higher price, utilizing a Pelton turbine to generate mechanical energy using the difference between the potential energy of the water at the higher reservoir and the lower reservoir and thereby transferring water from the higher reservoir to the lower reservoir; converting the mechanical energy to electrical energy; and when the mechanical power is not being generated, maintaining the Pelton turbine in a spinning stand-by mode.

### PRIORITY CLAIM

This non-provisional patent application claims the benefit of United States Provisional Application No. 61/903,168, filed Nov. 12, 2013, the disclosures of which are incorporated herein by reference.

### BACKGROUND

The invention relates to a method for storing energy.

U.S. Pat. No. 7,003,955 suggests a system for pumped storage of energy which utilizes a high elevation reservoir, and a low elevation reservoir, and a combination of pump and turbine that can either be used to generate electricity as water is transferred from the high reservoir to the low reservoir, or used to pump water from the lower reservoir to the higher reservoir. The object of this system is to generate electricity when electrical energy is needed, and when electrical energy is available in access, utilize that excess electrical energy to replenish the upper reservoir. This patent claims a system that utilizes a reversible turbine and generator unit. The reversible unit is also utilized as a motor and pump when energy is available to pump water to the higher reservoir. The advantage is that fewer pieces of equipment are needed, but a disadvantage is that reversing the direction of rotation, and reversing the momentum of the water takes a finite amount of time to achieve. Thus refersal of the operation is not quick.

US patent application publication US20090160192 suggests an energy storage system where water wheels are used to convert potential energy from higher elevation stored water to mechanical energy, and then electrical energy, and a separate pump and electrical motor are used to replenish the water in the higher elevation.

Energy storage systems such as the system suggested in U.S. Pat. No. 7,003,955 are expected to be needed as the amount of electricity provided from sources such as wind turbines and solar uses increases. Electricity from solar panels typically may be used locally, rather than proviced to the grid, but unless sufficient battery storage is provided to make the instillation self-sufficient, the effect of the increase in electrical power demand when solar power is not available accumulates and could become significant. Energy balancing could be provided by having hydrocarbon or nuclear powered electrical generation capacity on stand-by or operating at considerably less than capacity when wind or solar power generation is available, but this is inefficient and relatively expensive. It is also a problem to rapidly increase output from these types of electrical generation facilities.

Pelton turbines were first patented in 1888, and are commercially available. Pelton turbines use wheels with curved buckets around the circumference to capture jets of water directed tangentially around the wheel. The curved buckets redirect the velocity of the water efficiently, and thus convert a large portion of the kinetic energy from the jets of water to mechanical energy. At design conditions, Pelton turbines can be ninety percent efficient with respect to conversion of kinetic energy of the water to mechanical energy in the shaft. U.S. Pat. No. 7,927,064 and application publication nos. US20130101407 and US20100254814, the disclosures of which are incorporated herein by reference, describe improvements to Pelton turbine systems.

### SUMMARY OF INVENTION

The present invention is a method for storing energy comprising the steps of: during a time period when electrical energy is available at low prices, pumping water from a lower reservoir to a reservoir at a higher elevation wherein the difference between the elevation of the higher reservoir and the lower reservoir is at least 100 meters; during a time period when electrical energy is available at a higher price, utilizing a Pelton turbine to generate mechanical energy using the difference between the potential energy of the water at the higher reservoir and the lower reservoir and thereby transferring water from the higher reservoir to the lower reservoir; converting the mechanical energy to electrical energy; and when the mechanical power is not being generated, maintaining the Pelton turbine in a spinning stand-by mode.

### BRIEF DESCRIPTION OF THE FIGURE

FIG. 1 is a schematic drawing of the system of the present invention.

### DETAILED DESCRIPTION

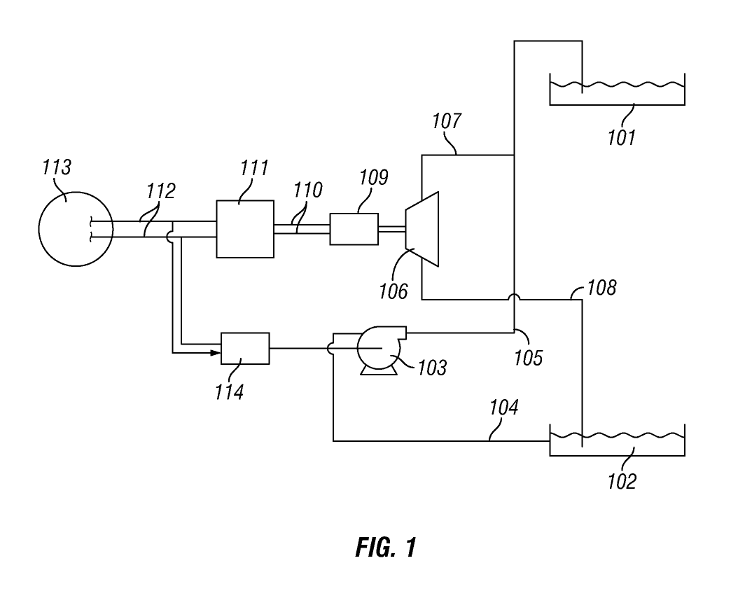

Referring now to FIG. 1, an reservoir at a higher elevation 101 and a lower reservoir 102 are shown. The differences in elevation between the two reservoirs may be, for example, at least one hundred meters, or in another embodiment, at least three hundred meters. The difference in elevation is limited by only the differences in elevation available in the local geography, along with the cost of providing sufficient Greater elevations are advantageous because greater elevations enable greater energy storage for similar sized reservoirs. The size of the reservoirs may be, for example, between 100 acre feet and 4000 acre feet or in another embodiment, between 400 acre feet and 2000 feet. One or both of the reservoirs could be an existing lake or aquifer.

The system of the present invention may include a pump 103 with a suction line 104 capable of pumping water from the lower reservoir, to a discharge line 105, which is routed to the reservoir at the higher elevation.

The system of the present invention also includes a Pelton turbine 106, which may remove water from the discharge line routed to the reservoir at the higher elevation through inlet line 107, to a discharge line 108, which is routed to the reservoir at the lower elevation.

The pelton turbine drives generator 109, which generates power to electrical lines 110, which route electrical power via transformers and switch gear 111, to power grid lines 112 to a power grid 113. The power grid lines may also power a motor 114, capable of driving the pump 103. The Pelton turbine could be a commercially available turbine generally used, for example, to generate electricity at dams. The Pelton turbine, when not in operation, is preferably left spinning in a stand-by mode. Maintaining the turbine spinning in a stand-by mode is advantageous because it permits rapid change of modes between modes of taking power from the grid to supplying power to the grid. Being able to rapidly change modes like this enables the operator to take advantage of quickly changing electrical demands and quickly changing electrical supplies available to the power grid as might be caused, for example, but passing weather over a wind farm, or clouds passing over a solar panel farm, or mearly to take advantage of hour to hour changes in the price for electricity.

A spot market for short term energy exists in the western United States of America where price paid for electricity vary dramatically over the course of each day, and from week to week. The present invention is preferably operated in close coordination with spot market purchase and sales of electricity so that periods of power generation, power usage, and idle time, are changed quickly to changes in the market, with power being generated when prices are more favorable, and water is pumped to the higher elevation when prices are lower.

Rapid responses to market conditions are possible with the use of separate pumps and turbines rather than a common practice of utilization of one piece of equipment to both pump and to extract power from the stream of water. By rapid response, it is meant that the turbine could be brought on like from a spinning stand-by status in less than one minute. By a spinning stand-by mode, it is meant that the turbine is rotating at nearly normal operating speed, but not generating significant amount of electricity.

The Pelton turbine is also generally a very efficient design for extraction of mechanical power from high pressure water. The reason typically cited for this efficiency is that the geometry of the scopes of the turbine convert essentially all of the kinetic energy of the water hitting the scope to power. Thus efficiencies can exceed nighty percent of the potential energy in the high pressure stream of water. Pelton turbines, on the other hand, are not useful as pumps as are many centrifugal pumps which an be used to convert potential energy into mechanical energy when fluids are forced through them from the normal suction to the normal discharge.

A separate motor and generator are shown in FIG. 1, although it is understood that the present invention could be practiced with a combination motor and generator coupled to both the Pelton turbine and the pump. Clutches could be included in couplings between the combination generator and motor and one or both of the Pelton turbine and pump.

Deflection plates, or fail safe deflection plates, may be utilized at the inlets of the Pelton turbines to close off water inlet in the event of high speed of the pump. Deflection plates can react quickly without damaging the either the pump, or causing water hammering in the pipes due to sudden changes in the kinetic energy of the fluids flowing in the pipes extending to the reservoir located at the higher elevation.

What is claimed is:

1. A method for storing energy comprising:
during a time period when electrical energy is available at low prices, pumping water from a lower reservoir to a reservoir at a higher elevation wherein the difference between the elevation of the higher reservoir and the lower reservoir is at least 100 meters;
during a time period when electrical energy is available at a higher price, utilizing a Pelton turbine to generate mechanical energy using the difference between the potential energy of the water at the higher reservoir and the lower reservoir and thereby transferring water from the higher reservoir to the lower reservoir; and
converting the mechanical energy to electrical energy; and
when the mechanical power is not being generated, maintaining the Pelton turbine in a spinning stand-by mode.

2. The method of claim 1 wherein the difference between the elevation of the higher reservoir and the lower reservoir is at least 300 meters.

3. The method of claim 1 further comprising selling electricity into a power grid when electrical energy is available at a less favorable price.

4. The method of claim 3 further comprising utilizing electrical power from the power grid when electrical energy is available at a more favorable price.

5. The method of claim 1 wherein the difference between the more favorable price and the less favorable prices is greater than thirty percent of the more favorable price.

6. The method of claim 1 wherein when the Pelton turbine is in the spinning stand-by mode, the electrical generator remains synchronized with a power grid.

7. The method of claim 1 further comprising pumping water from the lower reservoir to the reservoir at the higher elevation when water is required at the higher elevation and electrical energy is available at favorable prices.

8. The method of claim 1 further comprising utilizing the Pelton turbine to generate mechanical energy when excess water is available at the higher elevation and the electrical energy is commercially available at a less favorable price,

9. A system to store energy comprising:
a lower reservoir;
a pump operatively associated with the lower reservoir effective to remove fluid from the lower reservoir into its suction, and having a discharge;
a conduit having two ends, one end connected to the discharge of the pump;
a higher reservoir connected to a second end of the conduit;
a Pelton turbine effective to generate mechanical energy using the difference between the potential energy of the water at the higher reservoir and the lower reservoir and thereby transferring water from the higher reservoir to the lower reservoir; and
an electrical generator capable of converting the mechanical energy into electrical energy.

10. The system of claim 9 further comprising fail save deflection plates located on a inlet to the Pelton turbine.

11. The system of claim 1 wherein the difference in elevation between the lower reservoir and the higher reservoir is at least one hundred meters.
